(19) United States
(12) Patent Application Publication
(10) Pub. No.: US 2005/0132251 A1
(43) Pub. Date: Jun. 16, 2005

(54) Method for handling data, data storage system, file system and computer program product

(75) Inventors: Adrianus Johannes Maria Denissen, Eindhoven (NL); Robert Jochemsen, Eindhoven (NL); Nicolaas Lambert, Eindhoven (NL); Hong Li, Eindhoven (NL); Albert Maria Arnold Rijkaert, Eindhoven (NL); Rudi Josef Marie Wijnands, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/502,525

(22) PCT Filed: Dec. 23, 2002
(86) PCT No.: PCT/IB02/05725

(30) Foreign Application Priority Data
Jan. 29, 2002 (EP) 02075351.3

(51) Int. Cl. G06F 11/00

(52) U.S. Cl. 714/8

(57) ABSTRACT

In a file system and in particular in a real-time file system it might not be possible to write a data to disc completely. Nevertheless the data that has been written to disc is often still useful, for example in case of an MPEG-stream. Marking parts of the file defective in the file system providing meta-data enables an application to perform application specific error correction or error concealment By using a filter driver, the file system can be extended with this error handling, thus making this functionality available to every application.

The invention relates to a method for handling data wherein data are recorded at a data storage medium and physical information on erroneous recorded data are identified. The invention further relates to a data storage system comprising a data storage medium and a file system, further to a file system and further to a computer program product.

Traditional data oriented file systems tend to aim for maximum data integrity, delaying completion of each command until properly executed. Such measure may be taken by the hard disc drive or the file system. In general “some data lost” is put equal to “all data lost”. This choice is visible in both the file system formats used on a disc as well as in application programming interfaces (APIs) for communication of an application with the file system. This approach is not very suitable for contemporary demands of operating systems, in particular not for operating systems dealing with streaming of data.

In particular traditional data oriented file systems have no real-time requirements and the outlined approach of aiming for maximum data integrity is in particular not suitable for streaming of data which demands for high processing performance and effectiveness. In particular data are to be processed within certain time limits. Thereto adapted hard disc or disk based devices recording multimedia streams like MPEG-encoded video require a real-time file system for writing their data to disc or disk and for reading the data back. In the following “disc” terms all kind of discs or disks usable as a data storage medium.

Real-time file systems try to write all data in time, but sometimes don't succeed, for example because of disc problems. There are then two options: writing the data too late, or discarding some of the unwritten data. The first option will typically cause buffer overflows for recording, which can lead to a significant data loss. The second option will keep data loss low. Especially in combination with a hard disc comprising a time limit restriction for data transmitters and an appropriate scheduler, this scheme will at least keep data loss low.

A scheme for writing data, in particular an audio/video stream (A/V-stream), to a hard disc drive system under time restrictions may be adapted such that data are stored within a predetermined time limit. Thereupon a hard disc drive system may detect write errors. Also due to time restrictions, data may not be fully written to disc. This means, that the data in the stream stored on disc is undefined. This in particular means, that data is either erroneous or it belongs to a totally different stream. So basically, it is undefined what is on the disc, but will in most cases be the old data. In all these cases such data will be referred to as “erroneous” data.

Physical errors of a hard disc may be handled according to a defect management method known from prior art relying on allocation and re-allocation schemes, sometimes referred to as a skip-and slip-scheme for erroneous sectors on a hard disc. I. e. such schemes only provide for measures with regard to physical information of erroneous data, like erroneous blocks or locations on the disc, which are related and restricted to the hard disc drive system as such. Within the mentioned defect management methods errors may be concealed or corrected by writing data originally scheduled to be written to a defect sector of a hard disc drive to a spare area of a hard disc drive. Thereby a defect sector is skipped and data originally scheduled to be written to such defect sector are written in a spare area on the hard disc drive. When applying such conventional scheme there are certain disadvantages. In particular as a data transfer head usually has to perform track switching or at least is not able to read from an originally scheduled sequence of a physical block addresses, such conventional schemes, relying on physical information for defect management, will take extra time.

In the EP 0 880 136 a data reproducing apparatus is disclosed wherein upon reproduction of data a reproducing means reproduces data from a recording medium on the basis of error information already stored in a register in the hard disc drive. Such method is not able to prevent or timely indicate an access to erroneous data, as erroneous data are only indicated during reproduction of data. This will cause a performance loss and take extra time during reproduction of data. Also error information is generated only during reproduction of data from a recording medium.

In the EP 0 953 977 it is proposed to report the magnitude of recorded data to an application layer when an allocation area is deficient in a recording step. Such magnitude information only relies on physical information of the hard disc drive.

A defective block or sector of the hard disc may be generated during recording in an unrecorded area of the hard disc drive. In the EP 0 953 977 conventional file defect management is applied to provide information indicating a replacement of a defective block with a block in a spare area of the hard disc drive to prevent re-reading or re-writing of the defective block on the hard disc drive. Such scheme only relies on physical defect management information within the lowest layer of a data processing system i. e. a hard disc drive layer or other data storage device layer. E.g. physical information regards indicating a replacement of a defective block with a block in a spare area of a disc drive.

Such scheme still depends on waiting for error detection until reading when the data is needed for playback. The hard disc drive system will try to recover errors by a defect management scheme relying on re-allocation, re-mapping or skip-and slip-methods for defect sectors of the hard disc drive. This will take time, usually some seconds, before the error recovery processes of a hard disc drive system are exhausted. A time restriction for such recovery scheme may be set on reading of data. Then the loss of time due to failed efforts to recover data is limited, but still time is lost.

Another problem is that due to non-writing of data some old data is kept on the disc as part of the new stream. By this way internal hard disc error correction code information will be valid and during reading the packet will be considered as correct by the hard disc. This may result in serious decoding errors.

In particular the teaching of EP 0 953 977 relies on reporting of physical defect information to an application layer. Thereby such physical defect information will be lost for an application layer and other layers of a data storage system any way after a deactivation of such application or after shut down of a computer system. It is possible to store such information in a file to be read and possibly executed during initialisation of an application. However this will cause time delay and is not a convincing or preferable solution. By only relying on physical defect information at the lowest layer of a data system a precise and early defect management is not likely to be performed.

This is where the invention comes in, the object of which is to specify a method for handling data, a data storage system, a file system and a computer program product which is capable to define erroneous data more efficiently, in particular timely and precisely, and further to make information of erroneous data temporarily available, even after a shut down of a computer system or a deactivation of an application on the computer system.

Regarding the method, the object is solved by a method for handling data wherein data are recorded at a data storage medium and physical information of erroneous recorded data are identified, wherein in accordance with the invention it is proposed that for handling data at a file system logical information on the erroneous recorded data are identified and registered at a file system layer during or immediately subsequent the recording of data.

The invention also leads to a data storage system comprising a data storage medium and a file system, wherein in accordance with the invention the system further comprises a filter driver for identifying and registering logical information of erroneous recorded data at the file system layer during or immediately subsequent the recording of data.

Further the invention leads to a file system storable on a computer readable medium wherein in accordance with the invention a filter driver for identifying erroneous recorded data and a file system for registering logical information of erroneous recorded data during or immediately subsequent to the recording of data is provided.

Further the invention leads to a computer program product storable on a medium readable by a computer system comprising a software code section which induces to execute the method as proposed when the product is executed on a computer system.

A data storage medium and a computer readable medium may be any kind of medium suitable for storing data thereon. In particular an optical disc comprised by a disc drive or a magnetic disk comprised by a disk drive is suitable with regard to the proposed method and apparatus. A disc drive or disc as termed in this application is meant to comprise all kind of disc and disk drives or discs and disks suitable for data storage, in particular also optical discs and magnetic disks.

The main idea of the invention is to implement a defect management scheme within the file system layer as the file system layer is a system layer capable of giving precise information of defective parts of a file, having defect information temporarily available and being capable to register such information timely, i. e. at an early stage of defect detection, in particular well before reading of data.

Logical information may comprise any information of data directly regarding a file of data. Such information e. g. may be given in the smallest allocatable unit of a file, a logical allocation unit. Logical allocation units of a file in a file system may be used or offset or byte information of a file or any other logical information capable to mark a part of a file being defective. Such logical information is capable of marking spots inside a file and may be any kind of software marker. Further registering such information allows to keep such information available for later applications. The information may be persistently stored and is at least temporarily available i. e. as well during an application as also after deactivation of an application. In particular the information is permanently available even after a shut down of a computer system.

The information is not only reported but registered. Such information is also registered at a file system layer which makes sure that when a restart of an application or the computer system is performed one would not be confronted with the same problems as before the shut down. Due to registering, the information remains available for a later application, for retrieving the information or for reproducing defective data. Furthermore relying on logical information allows to precisely mark those parts of a file which are defective. During a write operation for a file a write implementation may mark those parts of a file that could not be written to a disc as defective.

Various advantages are achieved. The proposed scheme ensures that most data will be on the disc without substantial data loss and that the locations in the file of missing parts thereof are known. This makes it possible to apply application specific error correction or error concealment either on-the-fly during playback or as a background process repairing a file. The proposed scheme keeps data loss low. In particular due to application specific error handling, perceptual data loss is even lower. Hardly any extra processing is needed for e. g. error correction at reading or playing of audio/video information. Hardly any further processing during playback is necessary if a file has been repaired. Therefore, time loss at playback is kept low.

Further continued developed configurations of the invention are outlined in the dependent claims.

Regarding the proposed method advantageously handling of data is adapted for real-time handling of data. In this case a data storage system or a file system as proposed are adapted to comprise a real-time file system. If during recording the real-time file system cannot write all data to a disc in time e. g. MPEG-data would conventionally be lost and there is no aid to retrieve the lost data again. According to the proposed scheme the real-time file system is capable to register the file locations of lost data. Such logical information is registered in a layer of the real-time file system. The proposed scheme is applicable for any application, also for applications without specific MPEG-knowledge.

Further additional, physical information of the erroneous recorded data may be identified and registered also to a file system layer during or immediately subsequent the recording of data. This may enhance processing effectivety.

Any data not recorded due to predetermined time restrictions may be identified as erroneous recorded data. Therefore no old data, that may still be correct would be retrieved if necessary. This allows to improve data retrieval and playback. Advantageously, erroneous data comprised by a latest recorded data stream are recorded.

The logical information may include any data assigned as virtual regarding a file, in particular one or more among the following: the erroneous recorded data of a file itself, at least part of a data stream recorded latest, software identifier marks of erroneous recorded data of a file, location of erroneous recorded data in a file, in particular identifying an address space and/or range. Such information may be given in terms of logical allocation units, bytes, or offset defining defective or erroneous areas of a file.

Logical information in the file system layer may be communicated by any communication means to an application layer, a host system or a further higher layer. In particular an application programming interface (API) may be applied. Further a device driver may also be used.

Data handling may advantageously comprise recording and reproducing the data at a data storage medium. In particular the logical information of erroneous recorded data could be applied to retrieve data corresponding to the erroneous recorded data during reproduction of the data in a proper way. This may be performed in any way suitable for an application. In particular an API for the application is capable for retrieving which parts of a file are defective. A file may be read only via an API which takes these defective parts into account, preferably by reporting back about any non-retrievable defective parts. The erroneous data may be properly concealed, adapted or corrected to constitute the retrieved corresponding data.

In principle reproduction may include at feast one or more among the following: read-back of data, and also background repairing of data. The logical information is advantageously applied to retrieve data corresponding to the erroneous recorded data in a proper way. This may include one or more among the following: repair of erroneous recorded data, extra transmitting of erroneous recorded data or corresponding data thereto, storing the logical information and later-on-repair of the erroneous recorded data, replacement of erroneous recorded data.

In particular for real-time applications such data may be MPEG-data. In a preferred configuration the application may re-write the erroneous locations of a file at a later moment with MPEG packets in which a transport error indicator bit in a transport packet comprised by the MPEG-stream is set. This would create a completely written file with a valid MPEG-stream, which can be used directly for playback.

Further if during playback a real-time file system reports that the data is incomplete or possibly incorrect the application may set the error bit in the affected MPEG-packets to improve playback quality. Such measure is particularly useful to avoid decoding problems as those known from prior art mentioned above.

Regarding the proposed data storage system or file system, a configuration of the data storage system may further comprise a filter driver for identifying and registering logical information of erroneous recorded data to the file system layer during or immediately subsequent the recording of data. Advantageously, further the system comprises a registration means comprised by the file system layer, which may be advantageously an administration layer or also a filter driver. Also a registration means, on top of the file system layer is possible, thereby extending the functionality of the file system.

For communicating erroneous recorded data or information thereof between the file system layer and the application an improved configuration of the data storage system may further comprise an application layer and a communication means. Advantageously an application programming interface may be used as a communication means. Also as a further possibility a device driver located between the application and the file system layer may be used as a communication means. A device driver usually locates between an operating system and a hardware unit; for this possibility is meant to be located between the file system layer and the application. Also an extra API may be made available by a filter driver. A filter driver or a device driver of such possibility is termed driver.

Regarding the system of the proposed scheme, a filter driver is used advantageously also for application of specific error handling. A filter driver can in modern operating systems be put on top of the file system as a further layer extending the functionality of the file system. By adding such an application specific filter driver all applications can benefit from on-the-fly error concealment and error correction. Otherwise, each application needs to do its own error handling. The logical information data are available for higher layers in the proposed embodiment e. g. application software. In prior art physical information is to be remained in a device layer of an embodiment. In the proposed scheme availability of logical information data to higher layers enable availability of error information prior to the start of a data stream. The higher layers may desire themselves how to handle the erroneous packets. In conventional systems write errors may be passed to higher layers only a long time after the write command has been given and finished from the application point of view. The reason for this is that at a write command, data is put in a cache and is then written later. However, immediate writing to the hard disc drive is advantageously desired in the proposed scheme to be available, identified and registered to a file system layer. Such availability may be enforced by flushing the cash. Thereby, error messages may be forced.

Preferred embodiments of the invention will now be described with reference to the accompanying drawings. These are meant to show examples to clarify the inventive concept in connection with the detailed description of a preferred embodiment. The drawings illustrate in:

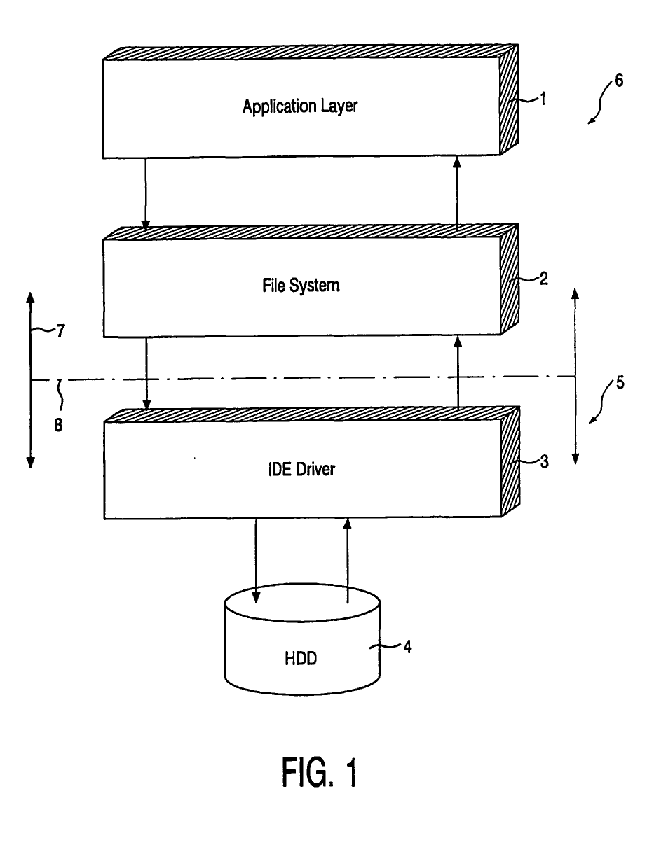

FIG. 1 a data system scheme comprising a lower layer portion relying on physical address space and a higher layer portion relying on logical address space;

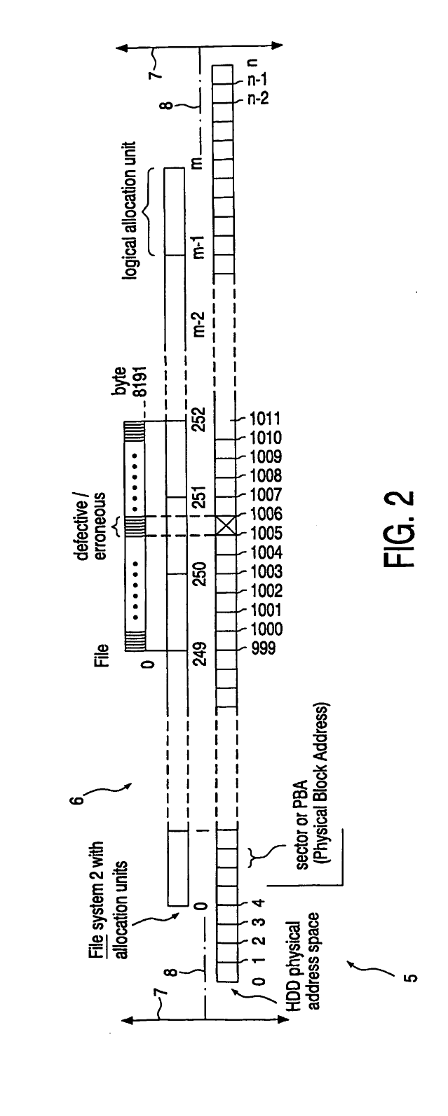

FIG. 2 an example of translation of sectors of a physical address space to units of a logical address space;

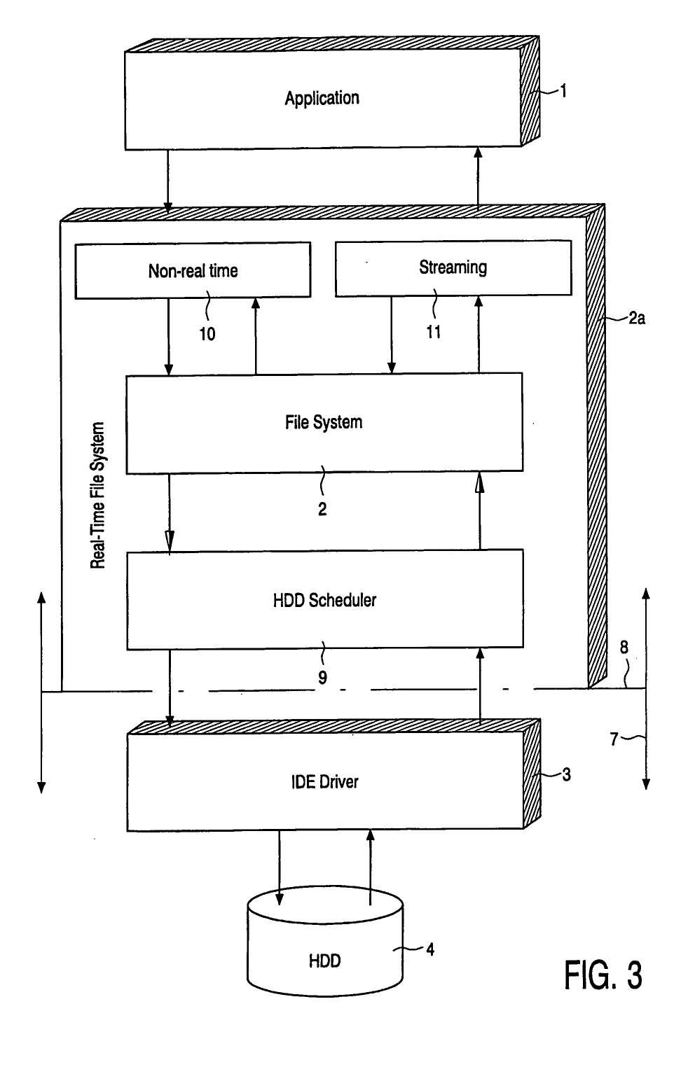

FIG. 3 a system as illustrated in FIG. 1 adapted for real-time application.

FIG. 1 shows a possible layered architecture with an application 1 that uses a file system 2 of the proposed preferred kind to access a hard disc 4 via an IDE-driver 3. The data system comprises a lower layer portion 5 relying on a physical address space. Further a higher layer portion 6 relies on a logical address space. Translation 7 of physical addresses to logical address, usually done in the file system, is to be provided across the line 8.

For handling error messages during writing and storing error and/or error recovery information during writing, in particular two embodiments are proposed:
1. Record the error during storage by registration of the error in meta data at the layer of the file system or up.

At play back, data is retrieved and the corresponding meta data is checked. If the meta data indicates erroneous data, the part is not retrieved from the disc. In this case, or when disc access results in an error, two options are proposed:
a) ‘Repair’ the stream by setting the transport error indicator (TEi) bit in the header of the transport stream packet. This can be done by setting the TEi bit only or by initialising the full packet header and setting the TEi bit. In the first case, the TEi bit has to be checked directly at reading the packet (by the interpolator/decoder). In the second case, this is not necessary, since the header is a valid format.
b) Send an extra parameter outside the stream (e. g. by an additional internal link or by a firewire or USB when the system comprises at least two apparatuses) and optionally plus the invalid packet.
2. Record/store all data in the HDD system as offered by the host and keep administration of erroneous locations in the memory. In idle time, repair the bad parts on the disc, e. g. by interpolation or setting the TS packet transport error bit.

FIG. 2 of the drawings shows how a file system 2 with its files mapped and translated 7 from the logical address space 6 onto the physical address space 5 of a hard disc across the line 8. The example shows a file system 2 that starts its first logical allocation unit at sector #4 and has logical allocation units with a size of four physical sectors. This can of course be any arbitrary number as well as the start location of the first logical allocation unit. In the example it is assumed that physical sectors are of 512 bytes size. This can of course also be any arbitrary number and in practice this will be depend on the particular hard disc. One hard disc sector contains e. g. 512 bytes, so the size of an allocation unit is 2048 bytes. In the example a file is starting at logical allocation unit #249, i. e. at sector #999. If sector #1005 is defect, this means byte #3072 to byte #3584 must be marked, as defective. In the example a file is stored from #249^{th} allocations unit up to allocation unit #252. This means the file consumes four logical allocation units from the file system allocation space. In this example physical sector #1005 is defect, which is the third sector assigned to logical allocation unit #250.

The file will be addressed by an application from its first byte to its last byte. The application has no knowledge of logical allocation units or physical sectors. Since the file is four allocation units large, the bytes in the file are addressed from byte #0 to byte #8191. Sector #1005 is the 7^{th} sector in the file, so byte #3072 is the first byte to possibly contain erroneous data up to byte #3584. These bytes are marked defective in the file system administration data in whatever way that may be stored. Additionally these bytes may also be marked defective in the application layer.

When the application tries to read from the file, the file system can make sure these bytes are not read, but that the error location and range are propagated to the application. It would also be possible to provide this information to the application beforehand via an additional API function.

E. g. this information is stored somewhere in the file system administration data. The application requesting this data can be informed that byte #3072 to #3584 possibly contain erroneous data according to the proposed scheme, instead of being informed that sector #1005 is defect according to prior art. Advantageously this can be done before the application requests the data as well via an API e. g. the file system might provide a function “get_file_errors”, which could then return the same information.

FIG. 3 shows a more sophisticated architecture that shows a real-time file system 2a as may be implemented instead of file system 2. The file system 2a has two API's 10 and 11. One API 10 for best-effort PC-like file access that provides normal file access functions like: open, close, read, write, seek etc. And a second API 11 for treating files as real-time streams with functions to access files as real-time streams, like: start_stream, stop_stream, pause_stram etc. The file system 2 within real-time file system 2a creates requests and issues them not directly to the hard disc, but to a hard disc request scheduler 9. This scheduler 9 determines the type of request. Best-effort or real-time, and orders the requests as such that real-time requests can always be served within their deadline. Real-time requests more or less get a higher priority. The scheduler 9 can also do much more advanced ordering techniques.

FIG. 3 is to indicate that the basic idea of the proposed scheme is not dependent on the concept of storing real-time files on the hard disc 4. Any file stored in the past can be treated as a real-time file. The non-real-time API 10 is used to open a file for reading or writing. Additionally real-time interface functions 11, 9 are used to connect an opened file to a stream. So when a file is opened for writing and start_stream is called by the application 1, then the file system or possibly additionally or alternatively the application has to provide data in real time to keep buffers from under-flowing. When a file is opened for reading, then the application 1 has to keep reading the buffer to keep it from over-flowing. Preferably there are obligations for the file system and no obligations for the application. In the preferred embodiment when a file is opened for writing then the application can provide data as generated by the streaming device of the buffers, while the file system has to store data in real time into the disc to keep the buffer from over-flowing. When the file is opened for reading then the file system has to keep reading data from the disc to the buffer to keep the buffer from over-flowing. With regard to time limit restrictions the host may provide the hard disc with a time limit for a particular command. The hard disc then has to try to store or retrieve as much data as possible within the given time limit. In the preferred embodiment of FIG. 3, the HDD scheduler 9 will typically calculate the time limit for a HDD command.

In particular in the case of concealment of errors caused by real-time system during retrieval of MPEG-data a real-time file system can return incomplete or incorrect data in case it does not have enough time to retrieve all data. In an MPEG-transport-stream, a transport_error_indicator (TEi) bit is defined in each packet that can be set to indicate an uncorrectable error during transport. A decoder can use this information to improve playback quality. An example of a transport_packet is shown below:

| Syntax | No. of bits | Mnemonic |
|---|---|---|
| transport_packet () { | | |
| sync_byte | 8 | bsibf |
| transport_error-indicator | 1 | bsibf |
| payload_unit_start_indicator | 1 | bsibf |
| Transport_priority | 1 | bsibf |
| PID | 13 | uimsbf |
| transport_scrambling_control | 2 | bsibf |
| adaptation_field_control | 2 | bsibf |
| Continuity_counter | 4 | uimsbf |
| if(adaptation_field_control == ‘10’ II adaptation_field_control == ‘11’){ | | |
| adaptation_field() | | |
| } | | |
| if(adaptation_field_control == ‘01’ II adaptation_field_control == ‘11’){ | | |
| for (i = 0; i < N; i++) { | | |
| data_byte | 8 | bsibf |
| } | | |
| } | | |
| } | | |

Semantic definition of fields in the transport stream packet layer are as follows:

The sync_byte is a fixed 8-bit field whose value is ‘0100 0111 ’ (0x47).

Sync_byte emulation in the choice of values for other regularly occurring fields, such as PID, should be avoided.

The transport_error_indicator (TEi) is a 1-bit flag. When set to ‘1’ it indicates that at least 1 uncorrectable bit error exists in the associated transport stream packet. This bit may be set to ‘1’ by entities external to the transport layer. When set to ‘1’ this bit shall not be reset to ‘0’ unless the bit value(s) in error have been corrected.

The payload_unit_Start_indicator is a 1-bit flag which has normative meaning for transport stream packets that carry specific packets or data.

When the payload of the transport stream packet contains a packet data of specific kind, the payload_unit_start_indicator has the following significance: a ‘1’ indicates that the payload of the transport stream packet will commence with the first byte of the packet and a ‘0’ indicates that no packet shall start in this transport stream packet. If the payload_unit_start_indicator is set to ‘1’, then one and only one packet of the specific kind starts in this transport stream packet. This also applies to private streams of a specific stream_type.

When the payload of the transport stream packet contains data of specific kind, the payload_unit_start_indicator has the following significance: if the transport stream packet carries the first byte of the specific data section, the payload_unit_start_indicator value shall be ‘1’, indicating that the first byte of the payload of the transport stream packet carries the pointer_field. If the transport stream packet does not carry the first byte of the specific data section, the payload_unit_start_indicator value shall be ‘0’, indicating that there is no pointer_field in the payload. This also applies to private streams of a further specific stream type.

For null packets the payload_unit_start_indicator shall be set to ‘0’.

The invention may be summarised as follows:

In a file system and in particular in a real-time file system it might not be possible to write a data to disc completely. Nevertheless the data that has been written to disc is often still useful, for example in case of an MPEG-stream. Marking parts of the file defective in the file system providing meta-data enables an application to perform application specific error correction or error concealment. By using a filter driver, the file system can be extended with this error handling, thus making this functionality available to every application.

While there has been shown and described what is considered to be a preferred embodiment of the invention it will of course be understood that various modifications and changes in form or detail could readily be made without departing from the spirit of the invention. It is therefore intended that the invention may not be limited to the exact form or detail herein shown and described nor to anything less than the whole of the invention herein disclosed as hereinafter claimed.

1. Method for handling data, wherein data are recorded at a data storage medium (4) and physical information on erroneous recorded data are identified,
characterised in that for handling data at a file system logical information on the erroneous recorded data are identified and registered at a file system layer (2, 2a) during or immediately subsequent the recording of data.

2. Method as claimed in claim 1, characterised in that the handling is adapted for real-time handling of data.

3. Method as claimed in claim 1, characterised in that identified physical information on the erroneous recorded data are registered to a file system layer (2, 2a) during or immediately subsequent the recording of data.

4. Method as claimed in claim 1, characterised in that any data not recorded due to predetermined time restrictions are identified as erroneous recorded data.

5. Method as claimed in claim 1, characterised in that the erroneous recorded data are comprised by a latest recorded data stream are registered at a file system layer (2, 2a) during or immediately subsequent the recording of data.

6. Method as claimed in claim 1, characterised in that the logical information includes one or more items selected from the group consisting of: the erroneous recorded data of a file, at least part of the data stream recorded latest, software identifier marks of erroneous recorded data of a file, location of erroneous recorded data in a file, in particular identifying a logical address space and/or range as defective or erroneous areas of the file, e. g. in terms of logical allocation units or bytes.

7. Method as claimed in claim 1, characterised in that the logical information in the file system layer (2, 2a) is communicated, in particular by an application programming interface or a driver, to an application layer (1), a host system layer or a further higher up layer.

8. Method as claimed in claim 1, characterised in that the handling comprises recording and reproducing of data at a data storage medium (4).

9. Method as claimed in claim 1, characterised in that the logical information on erroneous recorded data are applied to retrieve the erroneous recorded data properly during reproduction of the data.

10. Method as claimed in claim 1, characterised in that reproduction of data includes one or more items selected from the group consisting of: read-back of data, background repairing of data.

11. Method as claimed in claim 1, characterised in that the logical information are applied to retrieve the erroneous recorded data, which includes one or more items selected from the group consisting of: repair of erroneous recorded data, extra transmitting of erroneous recorded data, storing of the logical information and later-on-repair of the erroneous recorded data, replacement of erroneous recorded data, in particular by MPEG-data.

12. Data storage system comprising a data storage medium (4) and a file system, characterised by further comprising a filter driver for identifying and registering logical information of erroneous recorded data at a file system layer (2, 2a) during or immediately subsequent the recording of data.

13. Data storage system as claimed in claim 12, characterised in that the system further comprises a registration means comprised by the file system layer (2, 2a), in particular an administration layer.

14. Data storage system as claimed in claim 12 further comprising an application layer (1) and a communication means, in particular an application programming interface or a device driver, for communicating erroneous recorded data between the file system layer (2, 2a) and the application layer (1).

15. File system comprising a file system layer (2, 2a) and a filter driver, storable on a computer readable medium for identifying and registering logical information on erroneous recorded data at the file system layer (2, 2a) during or immediately subsequent to the recording of data.

16. Computer program product storable on a medium readable by a computer system comprising a software code section which induces to execute the method as claimed in preceding method claims when the product is executed on a computer system.

17. Apparatus for reproducing audiovisual information, comprising the data storage system according to claim 12.
